(19) United States
(12) Patent Application Publication
(10) Pub. No.: US 2023/0015929 A1
(43) Pub. Date: Jan. 19, 2023

(54) LEAN BURN INJECTOR WITH SUPPLY LINE SWITCHING

(71) Applicants: ROLLS-ROYCE PLC, London (GB); ROLLS-ROYCE DEUTSCHLAND LTD & CO KG, Blankenfelde-Mahlow (DE)

(72) Inventors: Michael R SMITH, Birmingham (GB); Imon-Kalyan BAGCHI, Berlin (DE)

(73) Assignees: ROLLS-ROYCE PLC, London (GB); ROLLS-ROYCE DEUTSCHLAND LTD & CO KG, Blankenfelde-Mahlow (DE)

(21) Appl. No.: 17/856,575

(22) Filed: Jul. 1, 2022

(30) Foreign Application Priority Data
Jul. 16, 2021 (GB) 2110242.1

(51) Int. Cl. F23R 3/28

(52) U.S. Cl. CPC F23R 3/28

(57) ABSTRACT

A lean burn fuel spray nozzle comprises: a lean burn fuel spray nozzle head comprising a pilot fuel injector with a pilot fuel injector outlet and a main fuel injector with a main fuel injector outlet; a feed arm adapted to feed pilot fuel from pilots pipework to the pilot fuel injector through a pilot fuel circuit and feed main fuel from mains pipework to the main fuel injector through a main fuel circuit; and a switching device comprising a switching valve adapted to switch between a Main On position, wherein the main fuel injector is in fluid communication with the mains pipework such that main fuel is sprayed through the main fuel injector outlet, and a Main Off position, wherein the main fuel injector outlet is not in fluid communication with the mains pipework such that main fuel is prevented to flow through the main fuel injector.

### CROSS-REFERENCE TO RELATED APPLICATIONS

This specification is based upon and claims the benefit of priority from UK Patent Application Number 2110242.1 filed on Jul. 16, 2021, the entire contents of which are incorporated herein by reference.

### BACKGROUND

### 1. Field of the Disclosure

The present disclosure relates to injectors for lean burn combustion systems, and in particular to injectors for lean burn combustion systems in gas turbine engines with improved heat management.

### 2. Description of the Related Art

Gas turbine engines are used in aircraft, industrial, and marine applications.

A gas turbine engine for aircraft applications typically comprises, in axial flow arrangement, a fan, one or more compressors, a combustion system and one or more turbines. The combustion system typically comprises a plurality of fuel injectors having fuel spray nozzles which combine fuel and air flows and generate sprays of atomised liquid fuel into a combustion chamber. The mixture of air and atomised liquid fuel is then combusted in the combustion chamber and the resultant hot combustion products then expand through, and thereby drive, the one or more turbines.

There is a continual need to reduce the environmental impact of gas turbine engines in terms of carbon emissions and nitrous oxides (NOx), which begin forming at high temperatures and increase exponentially with increasing temperature.

In order to address the NOx emission issue, the “lean burn” combustion technology has been proposed. In lean burn combustion the air-to-fuel ratio (AFR) is greater than a stoichiometric ratio, which allows to keep the combustion temperature within limits known to reduce NOx production.

Lean Burn combustion architectures feature Fuel Spray Nozzles (FSNs) that have two separated fuel streams: the “Pilots” streams and the “Mains” streams. The Pilots stream is always on and the Mains stream may be turned on and off. Turning on the Mains stream is known as ‘staging in’ and the split of fuel going down each stream when staged in is set by a control system in order to minimise emissions (usually smoke and NOx).

When the Mains stream is staged out (turned off) the fuel in the Mains pipework is stagnant and therefore picks up heat which is undesirable due to the effect on fuel conditions. Stagnant fuel poses a safety risk: firstly it might expand and fracture the pipework; secondly stagnant fuel when subject to heating breaks down, fuel breakdown products may pass to parts of the system and cause blockages.

To get around this problem known Lean Burn architectures feature recirculating fuel systems; when staged out these systems recirculate some fuel back to the central fuel system to keep a continuous flow. This requires a series of active valves and - since the splitting unit is mounted in a remote location—a great deal of additional pipework. This architecture includes active valves that switch flow on or off to the Mains fuel passageways in the FSN. An example of this architecture is disclosed in US 2018/0372322.

There is therefore a need to provide a lean burn combustion system for gas turbine engines for aircraft, industrial, and marine applications with reduced amount of pipework and active valve components, thereby reducing weight and complexity whilst not compromising on the key function of keeping the fuel in the lines flowing at a sufficient rate such that fuel breakdown products do not build up.

### SUMMARY

According to a first aspect, there is provided a lean burn fuel spray nozzle comprising: a lean burn fuel spray nozzle head comprising a pilot fuel injector with a pilot fuel injector outlet and a main fuel injector with a main fuel injector outlet; a feed arm adapted to feed pilot fuel from pilots pipework to the pilot fuel injector through a pilot fuel circuit and feed main fuel from mains pipework to the main fuel injector through a main fuel circuit; and a switching device arranged upstream of the feed arm, the switching device comprising a switching valve adapted to switch between a Main On position, wherein the main fuel injector outlet is in fluid communication with the mains pipework through the main fuel circuit such that main fuel is adapted to flow through the main fuel injector and be sprayed through the main fuel injector outlet, and a Main Off position, wherein the main fuel injector outlet is not in fluid communication with the mains pipework through the main fuel circuit and main fuel is prevented to flow through the main fuel injector. The switching valve in the Main Off position is adapted to put the mains pipework in flow communication with the pilot fuel injector through the pilot fuel circuit such that main fuel is permitted to flow in the pilot fuel circuit.

In contrast with the known fuel spray nozzles, when the Mains stream is staged out, in the fuel spray nozzle of the first aspect main fuel continues to flow in the pilot fuel circuit and therefore in the mains pipework, thereby minimising the risk of fuel picking up heat. Complex recirculating systems with additional pipework and valves are therefore no longer necessary to prevent the fuel in the mains pipework from being stagnant, thereby simplifying the lean burn architecture.

In the present disclosure, upstream and downstream are with respect to the fuel flow through the fuel spray nozzle.

When the switching valve is in the Main Off position, main fuel flowing in the main fuel circuit may be sprayed through the pilot fuel injector outlet.

The lean burn fuel spray nozzle may further comprise a flange adapted to secure the lean burn fuel spray nozzle to a combustor outer casing, the switching device being arranged upstream of the flange.

In use, when mounted to a combustor outer casing, the switching device may be configured to be arranged radially externally to the combustor outer casing.

In an embodiment, main fuel and pilot fuel may mix in the pilot fuel circuit, when the switching valve is in the Main Off position.

The lean burn fuel spray nozzle may further comprise a non-return valve arranged between the pilot fuel circuit and the main fuel circuit.

The switching valve may comprise an inlet adapted to receive main fuel from the mains pipework, a main outlet in fluid communication with the main fuel injector and a pilot outlet in fluid communication with the pilot fuel injector. The lean burn fuel spray nozzle may further comprise a connecting pipe adapted to connect the pilot outlet of the switching device with the pilot fuel circuit, the non-return valve being arranged along the connecting pipe. The non-return valve may be arranged upstream of the switching valve.

In an embodiment, the pilot fuel circuit may comprise a primary pilot fuel circuit including a primary pilot fuel supply pipe and a secondary pilot fuel circuit including a secondary pilot fuel supply pipe.

The primary pilot fuel supply pipe and the secondary pilot fuel supply pipe may be configured to supply respectively pilot fuel and main fuel to the pilot fuel injector outlet.

When the switching valve is in the Main Off position, the secondary pilot fuel circuit may be in fluid communication with the mains pipework.

When the switching valve is in the Main Off position, main fuel from the mains pipework may flow in the secondary pilot fuel supply pipe and may be sprayed through the pilot fuel injector outlet.

When the switching valve is in the Main Off position, main fuel from the mains pipework and pilot fuel from the pilots pipework are sprayed through the pilot fuel injector outlet.

When the switching valve is in the Main On position, the secondary pilot fuel circuit may not be in fluid communication with the mains pipework.

When the switching valve is in the Main On position, main fluid may flow in the main fuel circuit only.

In an embodiment, the secondary pilot fuel circuit may be connected to the mains pipework upstream of the switching valve at a junction. When the switching valve is in the Main On position, the secondary pilot fuel circuit may be in fluid communication with the mains pipework. In such embodiment, the lean burn fuel spray nozzle may further comprise a passageway restriction arranged in the secondary pilot fuel circuit downstream of the junction to limit the amount of main fuel flowing in the secondary pilot fuel circuit when the switching valve is in the Main On position.

The passageway restriction may be configured to allow a relative small amount of main fuel through the secondary pilot fuel circuit compared to the amount of main fuel flowing in the main fuel circuit when the switching valve is in the Main On position. For example, the passageway restriction may be configured to provide a ratio of the mass flow rate of main fuel flowing in the secondary pilot fuel circuit to the mass flow rate of main fuel flowing in the main fuel circuit less than 0.5, or less than 0.1, or less than 0.05, or less than 0.01 when the switching valve is in the Main On position. the ratio of the mass flow rate of main fuel flowing in the secondary pilot fuel circuit to the mass flow rate of main fuel flowing in the main fuel circuit may be less than 0.5, for example less than 0.1. The passageway restriction may be configured to provide the ratio of the mass flow rate of main fuel flowing in the secondary pilot fuel circuit to the mass flow rate of main fuel flowing in the main fuel circuit greater than 0.0001, or greater than 0.0005, or greater than 0.001 when the switching valve is in the Main On position.

According to another aspect, there is provided a gas turbine engine comprising: a fan comprising a plurality of fan blades; an engine core comprising a compressor, a combustor, a turbine, and a core shaft connecting the turbine with the compressor; wherein the combustor comprises a combustion chamber and a plurality of lean burn fuel spray nozzles according to the first aspect.

The gas turbine engine may further comprise a gearbox that receives an input from the core shaft and outputs drive to the fan so as to drive the fan at a lower rotational speed than the core shaft.

All of the features disclosed with reference to the lean burn fuel spray nozzle of the first aspect may apply to the gas turbine engine of the second aspect.

For example, the lean burn fuel spray nozzles of the gas turbine engine of the second aspect may comprise a non-return valve arranged between the pilot fuel circuit and the main fuel circuit.

For example, the switching valve of the lean burn fuel spray nozzles of the engine of the second aspect may comprise an inlet adapted to receive main fuel from the mains pipework, a main outlet in fluid communication with the main fuel injector and a pilot outlet in fluid communication with the pilot fuel injector; the lean burn fuel spray nozzles may comprise a connecting pipe adapted to connect the pilot outlet of the switching device with the pilot fuel circuit, the non-return valve being arranged along the connecting pipe.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

The gearbox may be arranged to be driven by the core shaft that is configured to rotate (for example in use) at the lowest rotational speed (for example the first core shaft in the example above). For example, the gearbox may be arranged to be driven only by the core shaft that is configured to rotate (for example in use) at the lowest rotational speed (for example only be the first core shaft, and not the second core shaft, in the example above). Alternatively, the gearbox may be arranged to be driven by any one or more shafts, for example the first and/or second shafts in the example above.

The gearbox may be a reduction gearbox (in that the output to the fan is a lower rotational rate than the input from the core shaft). Any type of gearbox may be used. For example, the gearbox may be a “planetary” or “star” gearbox, as described in more detail elsewhere herein. The gearbox may have any desired reduction ratio (defined as the rotational speed of the input shaft divided by the rotational speed of the output shaft), for example greater than 2.5, for example in the range of from 3 to 4.2, or 3 to 3.8, or 3.2 to 3.8, for example on the order of or at least 3, 3.1, 3.2, 3.3, 3.4, 3.5, 3.6, 3.7, 3.8, 3.9, 4, 4.1 or 4.2. The gear ratio may be, for example, between any two of the values in the previous sentence. Purely by way of example, the gearbox may be a “star” gearbox having a ratio in the range of from 3.1 or 3.2 to 3.8. In some arrangements, the gear ratio may be outside these ranges.

As used herein, cruise conditions have the conventional meaning and would be readily understood by the skilled person. Thus, for a given gas turbine engine for an aircraft, the skilled person would immediately recognise cruise conditions to mean the operating point of the engine at mid-cruise of a given mission (which may be referred to in the industry as the “economic mission”) of an aircraft to which the gas turbine engine is designed to be attached. In this regard, mid-cruise is the point in an aircraft flight cycle at which 50% of the total fuel that is burned between top of climb and start of descent has been burned (which may be approximated by the midpoint—in terms of time and/or distance—between top of climb and start of descent. Cruise conditions thus define an operating point of, the gas turbine engine that provides a thrust that would ensure steady state operation (i.e. maintaining a constant altitude and constant Mach Number) at mid-cruise of an aircraft to which it is designed to be attached, taking into account the number of engines provided to that aircraft. For example where an engine is designed to be attached to an aircraft that has two engines of the same type, at cruise conditions the engine provides half of the total thrust that would be required for steady state operation of that aircraft at mid-cruise.

In other words, for a given gas turbine engine for an aircraft, cruise conditions are defined as the operating point of the engine that provides a specified thrust (required to provide—in combination with any other engines on the aircraft—steady state operation of the aircraft to which it is designed to be attached at a given mid-cruise Mach Number) at the mid-cruise atmospheric conditions (defined by the International Standard Atmosphere according to ISO 2533 at the mid-cruise altitude). For any given gas turbine engine for an aircraft, the mid-cruise thrust, atmospheric conditions and Mach Number are known, and thus the operating point of the engine at cruise conditions is clearly defined.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any single speed within these ranges may be part of the cruise condition. For some aircraft, the cruise conditions may be outside these ranges, for example below Mach 0.7 or above Mach 0.9.

Purely by way of example, the cruise conditions may correspond to standard atmospheric conditions (according to the International Standard Atmosphere, ISA) at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise conditions may correspond to standard atmospheric conditions at any given altitude in these ranges.

Purely by way of example, the cruise conditions may correspond to an operating point of the engine that provides a known required thrust level (for example a value in the range of from 30 kN to 35 kN) at a forward Mach number of 0.8 and standard atmospheric conditions (according to the International Standard Atmosphere) at an altitude of 38000 ft (11582 m). Purely by way of further example, the cruise conditions may correspond to an operating point of the engine that provides a known required thrust level (for example a value in the range of from 50 kN to 65 kN) at a forward Mach number of 0.85 and standard atmospheric conditions (according to the International Standard Atmosphere) at an altitude of 35000 ft (10668 m).

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust.

According to an aspect, there is provided an aircraft comprising a gas turbine engine as described and/or claimed herein. The aircraft according to this aspect is the aircraft for which the gas turbine engine has been designed to be attached. Accordingly, the cruise conditions according to this aspect correspond to the mid-cruise of the aircraft, as defined elsewhere herein.

According to an aspect, there is provided a method of operating a gas turbine engine as described and/or claimed herein. The operation may be at the cruise conditions as defined elsewhere herein (for example in terms of the thrust, atmospheric conditions and Mach Number).

According to an aspect, there is provided a method of operating an aircraft comprising a gas turbine engine as described and/or claimed herein. The operation according to this aspect may include (or may be) operation at the mid-cruise of the aircraft, as defined elsewhere herein.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2 is a close up sectional side view of an upstream portion of a gas turbine engine;

FIG. 3 is a partially cut-away view of a gearbox for a gas turbine engine;

FIG. 4 is a schematic view of a lean burn fuel spray nozzle comprising a main and a pilot fuel circuits;

FIGS. 5a and 5b show schematically a layout of a switching device according to a first embodiment in a Main Off position and Main On position, respectively;

FIGS. 6a and 6b show schematically an arrangement of switching valve according to the first embodiment in a Main Off position and Main On position, respectively;

FIG. 7 is a schematic view of a lean burn fuel spray nozzle comprising a main, primary pilot, and secondary pilot fuel circuits;

FIGS. 8a and 8b show schematically a layout of switching device according to a second embodiment in a Main Off position and Main On position, respectively;

FIGS. 9a and 9b show schematically an arrangement of switching valve according to the second embodiment in a Main Off position and Main On position, respectively; and

FIGS. 10a and 10b show schematically a layout of switching device according to a third embodiment in a Main Off position and Main On position, respectively.

### DETAILED DESCRIPTION OF THE DISCLOSURE

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a core shaft 26 and an epicyclic gearbox 30.

In use, the core airflow A is accelerated in a core duct, compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

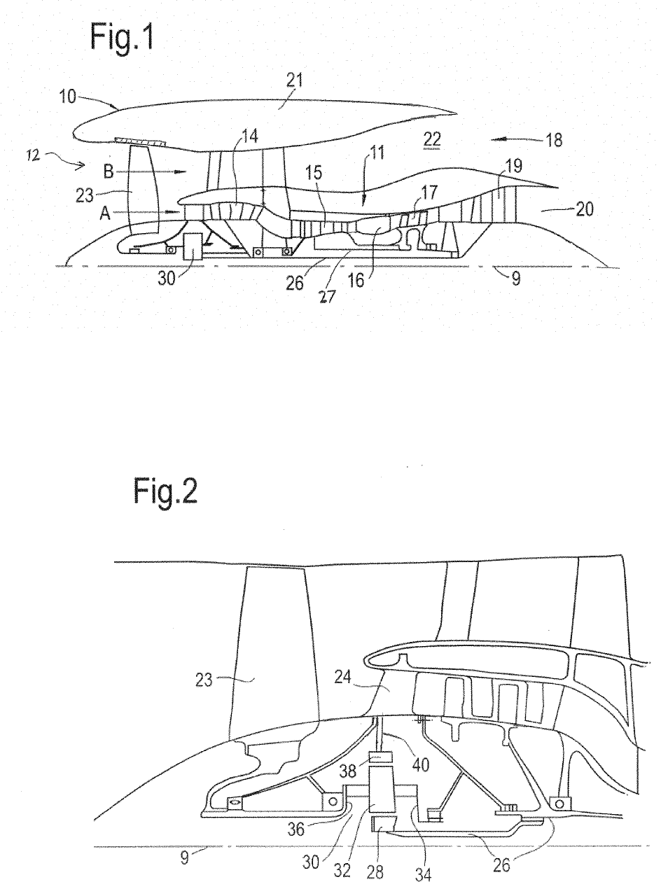

An exemplary arrangement for a geared fan gas turbine engine 10 is shown in FIG. 2. The low pressure turbine 19 (see FIG. 1) drives the core shaft 26, which is coupled to a sun wheel, or sun gear, 28 of the epicyclic gear arrangement 30. Radially outwardly of the sun gear 28 and intermeshing therewith is a plurality of planet gears 32 that are coupled together by a planet carrier 34. The planet carrier 34 constrains the planet gears 32 to precess around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the core shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

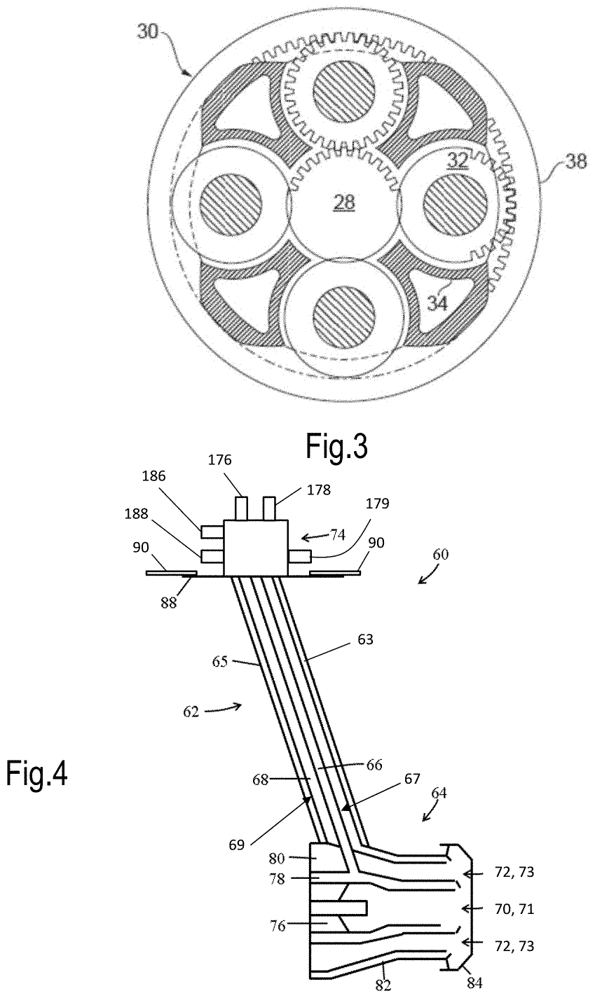

The epicyclic gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the claimed invention. Practical applications of a planetary epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclic gearbox 30 may be used. By way of further example, the epicyclic gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to rotate.

It will be appreciated that the arrangement shown in FIGS. 2 and 3 is by way of example only, and various alternatives are within the scope of the present disclosure. Purely by way of example, any suitable arrangement may be used for locating the gearbox 30 in the engine 10 and/or for connecting the gearbox 30 to the engine 10. By way of further example, the connections (such as the linkages 36, 40 in the FIG. 2 example) between the gearbox 30 and other parts of the engine 10 (such as the input, core shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 18, 20 meaning that the flow through the bypass duct 22 has its own nozzle 18 that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular. As used herein, front and rear is with respect to the gas turbine engine, i.e. the fan being in the front and the turbine being in the rear of the engine, and forward refers to the direction from the rear to the front of the gas turbine engine.

FIG. 4 illustrates a lean burn fuel spray nozzle 60 according to a first embodiment, providing two different supplies of fuel from a manifold (not illustrated for sake of simplicity).

The fuel spray nozzle 60 includes a feed arm 62 and a lean burn fuel spray nozzle head 64. The feed arm 62 delivers fuel from the manifold to the nozzle head 64, through a pilot fuel circuit 67 and a main fuel circuit 69 with respective pilot and main fuel supply pipes 66, 68. The feed arm 62 comprises a housing 65. The feed arm 62 may comprise a heat shield air gap 63 formed by the housing 65.

The nozzle head 64 mixes the fuel with air and delivers the mixture into a combustion chamber of the combustion equipment 16 as an atomised spray. The nozzle head 64 may also include heat shielding.

The pilot fuel supply pipe 66 is for delivering pilot fuel to a pilot fuel injector 70 with a pilot fuel injector outlet, or atomiser, 71 within the nozzle head 64, and the main fuel supply pipe 68 is for delivering main fuel to a main fuel injector 72 with a main fuel injector outlet, or atomiser, 73 in the nozzle head 64. In the example shown, the pilot fuel supply pipe 66 is arranged concentrically within the main fuel supply pipe 68.

The fuel spray nozzle 60 is provided with a flange 88. The flange 88 is arranged at an upstream end portion of the feed arm 62 and may be achieved integrally with the housing 65. In the assembled engine 10, the fuel spray nozzle 60 may be secured to a combustor outer casing 90, for example by fasteners, e.g. bolts.

The nozzle head 64 is substantially cylindrical, extending along an axial direction at an angle to the feed arm 63. Within the nozzle head 64, a first air swirler passage 76 extends substantially centrally. Around the first air swirler passage 76, a first annular fuel passage 78 is formed. The first annular fuel passage 78 is connected to, and in fluid communication with, the pilot fuel supply pipe 66 to provide pilot fuel to the pilot fuel injector 70.

A second air swirler passage 80 is provided concentrically radially outwardly of the first annular fuel passage 78, and a second annular fuel passage 82 is provided radially outwardly of the second air swirler passage 80. The second annular fuel passage 82 is connected to, and in fluid communication with, the main fuel supply pipe 68 to provide main fuel to the main fuel injector 72.

Each of the first and second air swirler passages 76, 80 receives air either from the low pressure compressor 14 or the high-pressure compressor 15, or both. The air swirler passages 76, 80 include swirler vanes (not shown) to impart turbulence to the air. Similarly, the first and second annular fuel passages 78, 82 also include swirler vanes (not shown) to impart turbulence to the fuel. A swirler head 84 may be provided on the outside of the second annular fuel passage 82 to provide further air to the main fuel injector 72.

In use, air from the first and second air swirler passages 76, 80 is mixed with pilot and main fuel from the first and second fuel passages 78, 82 to provide atomised fuel, to inject into the combustion chamber.

Although the fuel spray nozzle 60 has been described as having two air swirler passages, it will be appreciated that various alternatives are within the scope of the present disclosure. Purely by way of example, fuel spray nozzles with three, four, or five air swirler passages may be used. For example, in a three air swirler passage embodiment, a third air swirler passage may be provided concentrically radially outwardly of the second annular fuel passage 82; in a four air swirler passage embodiment, a fourth air swirler passage may be provided concentrically radially outwardly of the second air passage 80, to provide further air to the main fuel injector 72. Accordingly, the present disclosure extends to lean burn fuel spray nozzles 60 with a different architecture and having a different number of air swirler passages.

The fuel spray nozzle 60 further comprises a switching device, or staging valve, 74 for controlling the division of fuel between the pilot fuel injector 70 and the main fuel injector 72. The switching device 74 is arranged upstream of the feed arm 62 and the flange 88. In use, when the fuel spray nozzle 60 is connected to the combustor outer casing 90 at the flange 88, the switching device 74 is located radially outwardly of the combustor outer casing 90.

The switching device 74 receives fuel from the manifold and typically, at least some of the fuel is provided to the pilot fuel injector 70 at all times. The relative proportions of the fuel provided to the pilot fuel injector 70 and main fuel injector 72 is varied depending on environmental conditions and the mode of operation of the engine. For example, the proportion of fuel provided to the pilot fuel injector 70 is increased in circumstances, such as engine ignition, take-off, ascent, descent, idle or particular environment conditions. In some circumstances, 100 percent of fuel may be provided to the pilot fuel injector 70. A mixture of the main fuel injector 72 and pilot fuel injector 70, with varying contribution from the pilot fuel injector 70, is used at other times. For example at cruise, the ratio of the fuel supplied by the pilot supply to the fuel supplied by the main supply may be 20:80, or any other appropriate proportion. The switching device 74 controls the division of fuel between the pilot fuel injector 70 and the main fuel injector 72.

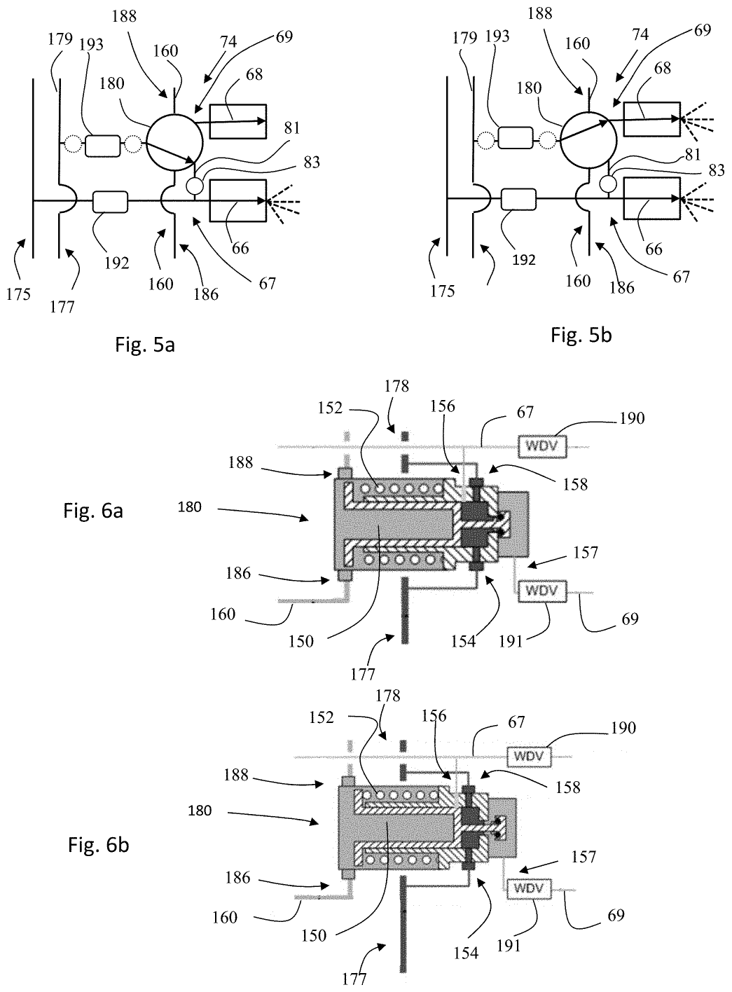

The switching device 74 will be now described in more detail with reference to FIGS. 4, 5a and 5b, which show schematically a layout of switching device 74 according to a first embodiment in a Main Off position and Main On position, respectively.

The switching device 74 comprises a first inlet 176 for receiving pilot fuel from a pilot fuel supply through a pilot pipework 175 and a second inlet 178 for receiving main fuel from a main fuel supply through a mains pipework 177. The switching device 74 further comprises a first outlet 179 for the main fuel to be delivered to the next fuel spray nozzle. The switching device 74 further comprises a switching valve 180 (shown as a circle in FIGS. 5a and 5b) in fluid communication with the second inlet 178. The switching valve 180 is configured to switch between a first, pilot-only (or main-off) position as shown in FIG. 5a, and a second, pilot and main (or staged, main-on) position as shown in FIG. 5b. The switching valve 180 includes an inlet adapted to receive main fuel from the mains pipework 177, and two outlets, i.e. a main outlet and a pilot outlet adapted to direct main fuel to either the main fuel injector 72 or the pilot fuel injector 70, respectively. In the pilot-only position, the main outlet is fluidly disconnected from the switching valve inlet. Subject to engine installation optimisation the pilot pipework 175 may be routed into the switching device 74 and then outed out again to the next fuel spray nozzle (similar to the mains arrangement). Alternatively, there may be a “T-piece” in the pilot pipework 175 such that only a single supply pipe connects the pilot pipework 175 to the switching device 74.

The pilot-only position of the switching valve 180 corresponds to staging out the main stream, whereas the pilot and main position of the switching valve 180 corresponds to staging in the main stream.

When in the pilot-only position, the switching valve 180 directs the main fuel from the main fuel supply to the pilot fuel supply pipe 66 of the pilot fuel circuit 67 of the fuel spray nozzle 60 through a connecting pipe 81. The connecting pipe 81 connects the pilot outlet of the switching device 180 with the pilot fuel circuit 67. In the pilot-only position all of the main fuel entering the switching device 74 through the second inlet 178 is diverted to the pilot fuel supply pipe 66 through the connecting pipe 81. When in the pilot-only position, the mains pipework 177 is in fluid communication with the pilot fuel supply pipe 66. Main fuel entering the switching device 74 can be adjusted as necessary, depending on the mode of operation of the engine, the flight condition, and/or the environmental conditions, by means of any suitable devices and systems, such as valves, for example weight distribution valves. Allowing main fuel to flow in the pilot fuel circuit 67 prevents the fuel in the mains pipework 177 to be stagnant and therefore to pick up heat. Compared with the known switching devices comprising on/off valves instead of the proposed switching valve 180, the present fuel spray nozzle allows fuel to continue to flow in the mains pipework 177 and therefore not to pick up heat.

When in the pilot and main position, the switching valve 180 directs the main fuel from the main fuel supply to the main fuel supply pipe 68 of the main fuel circuit 69. When in the pilot and main position, the main fuel circuit 69 is disconnected from the pilot fuel circuit 67. In other words, when in the pilot and main position, main fuel is not fed to the pilot fuel supply pipe 66.

The switching valve position does not affect the pilot fuel, in that the pilot fuel is only directed to the pilot fuel supply pipe 66 of the pilot fuel circuit 67, both when the switching valve 180 is in the pilot-only position and when the switching valve 180 is in the pilot and main position.

In normal operating conditions and when in pilots-only mode the pressure in the mains pipework 177 will be higher than in the pilots pipework 175, this ensures that cooling flow passes along the mains line before moving into the Pilots.

There are however failure cases where the mains pipework pressure can drop below the pilots pipework pressure whilst in pilots-only mode. One example would be when the switching valve 180 is stuck in the pilot and main position whilst it should be in the pilot-only position. To prevent reverse flow, i.e. fuel flow from the pilot fuel supply pipe 66 to the mains pipework 177 through the switching valve 180, a non-return valve (NRV) 83 may be provided between the pilot fuel circuit 67 and the main fuel circuit 69.

The NRV 83 may be placed between the switching valve pilot outlet and the pilot fuel supply pipe 66, for example along the connecting pipe 81, as illustrated in FIGS. 5a and 5b. In other words, the NRV 83 is arranged downstream of the switching valve 180. The NRV 83 may alternatively be placed upstream of the switching valve 180 in the fluid passage between the mains pipework 177and the switching valve 180.

Optionally, a restrictor can be incorporated with the NRV 83 or placed in series with it to influence the flow and pressure drop between the Pilots and Mains parts of the systems. This feature is also useful when sizing the system for failure conditions.

The NRV could be a conventional mechanical type valve for example a sprung ball-on-seat arrangement or could be a fluidic diode type, for example a ‘Tesla’ valve.

The switching valve 180 may be actuated electrically (for example through the use of solenoids, motors, or similar), pneumatically or hydraulically. To this purpose, when actuated pneumatically or hydraulically, as in the embodiment of FIG. 4, the switching device 74 further comprises a fluid actuation circuit 160 with an additional, third inlet 186 and an additional, second outlet 188 for an actuation fluid, such as air, oil, or any other suitable fluid.

Weight distributor valves (WDVs) may optionally be incorporated in the switching valve 180, and may be downstream or upstream of the switching valve 180 as illustrated in FIGS. 5a and 5b. In detail a pilot weight distributor valve 192 is arranged in the pilot fuel circuit 67. A main weight distributor valve 193 is arranged upstream of the switching valve 180 in the main fuel circuit 69. WDVs are used to correct for the effects of differential fuel manifold pressure head on the fuel distribution to the fuel spray nozzles 60. The NRV 83, if present, may be arranged either upstream or downstream of the main weight distributor valve 193 and upstream of the switching valve 180, as illustrated with dotted circles in FIGS. 5a and 5b.

An example of switching valve 180 will be now described in more detail with reference to FIGS. 6a and 6b.

The switching valve 180 comprises a chamber containing a movable piston 150, biased by a spring 152. The piston 150 is pneumatically, or hydraulically actuated by means of an actuation fluid flowing in a fluid actuation circuit 160 and supplied via the additional inlet 186 and discharged via the additional outlet 188.

The piston 150 is movable between a first position, corresponding to the pilot-only position of the switching valve 180, illustrated in FIG. 6a, and a second position, corresponding to the pilot and main position of the switching valve 180, illustrated in FIG. 6b.

When pressurised actuation fluid is provided to the switching valve 180, it exerts a force on the piston 150 that exceeds that of the spring 152, causing the piston 150 to move to, and maintain, the second position. When pressure of the actuation fluid is released, the spring 152 biases the piston 150 back to the first position.

The switching valve 180 may be understood as a four-way valve, with an input 154 for receiving main fuel from the second inlet 178 of the switching device 74, and a first 156, a second 157, and a third 158 output to deliver main fuel to the pilot fuel circuit 67, the main fuel circuit 69, and the next fuel spray nozzle, respectively. In other words, the third output 158 of the switching valve 180 is in fluid communication with the first outlet 179 of the switching device 74 of the next fuel spray nozzle 60.

When in the first position, the piston 150 closes the second output 157 and opens the first and third output 156, 158, allowing the input 154 to be in fluid communication with the pilot fuel circuit 67 and the next fuel spray nozzle. In other words, when the piston 150 is in the first position, main fuel entering the switching valve 180 is directed towards the pilot fuel supply pipe 66 and the mains pipework 177.

When in the second position, the piston 150 closes the first output 156 and opens the second output 157 (the third output 158 remains open), allowing the input 154 to be in fluid communication with the main fuel circuit 69 and the next fuel spray nozzle. In other words, when the piston 150 is in the second position, main fuel entering the switching valve 180 is directed towards the main fuel supply pipe 68 and the mains pipework 177.

It is to be noted that the third output 158 is open both in the first position and in the second position of the piston 150, allowing main fuel to flow in the mains pipework 177 at all times.

In alternative, non-illustrated embodiments, the switching valve may be configured such that when pressurised actuation fluid is provided, the piston 150 moves to the first position in which the second outlet 157 is closed and the inlet 154 is in fluid communication with the first output 156 to deliver main fuel to the pilot fuel circuit 67 and with the third outlet 158, whereas when pressure of the actuation fluid is released, the piston 150 moves to the second position in which the first output 156 is closed and the inlet 154 is in fluid communication with the second output 157 to deliver main fuel to the main fuel circuit 69 and with the third outlet 158.

Weight distributor valves (WDVs) are arranged downstream of the switching valve 180 as illustrated in FIGS. 6a and 6b. In detail a pilot weight distributor valve 190 is arranged downstream of the switching valve 180 in the pilot fuel circuit 67. A main weight distributor valve 191 is arranged downstream of the switching valve 180 in the main fuel circuit 69.

In alternative embodiments, as illustrated in FIGS. 5a and 5b, the pilot weight distributor valve and the main weight distributor valve may be arranged upstream of the switching valve180.

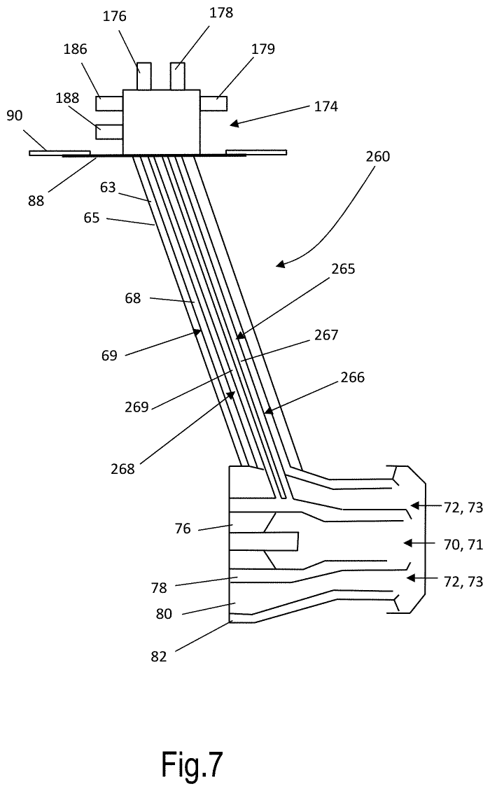

FIG. 7 schematically illustrates a lean burn fuel spray nozzle 260 according to a second embodiment.

The fuel spray nozzle 260 is similar to the fuel spray nozzle 60 described with reference to FIG. 4 and the same reference numerals are used to illustrate similar features. Mainly the differences between the fuel spray nozzle 60 and the fuel spray nozzle 260 will be described here.

The fuel spray nozzle 260 includes a feed arm 62 and a lean burn fuel spray nozzle head 64. The feed arm 62 delivers fuel from the manifold to the nozzle head 64, through a pilot fuel circuit 265 and a main fuel circuit 69 including a main fuel supply pipe 68. The feed arm 62 comprises a housing 65. The feed arm 62 may comprise a heat shield air gap 63 formed by the housing 65. The nozzle head 64 may also include heat shielding. The pilot fuel circuit 265 comprises a primary pilot fuel circuit 266 including a primary pilot fuel supply pipe 267 and a secondary pilot fuel circuit 268 including a secondary pilot fuel supply pipe 269.

The primary pilot fuel supply pipe 267 and the secondary pilot fuel supply pipe 269 are for delivering pilot and main fuel, respectively, to the pilot fuel injector outlet, or atomiser, 71 of the pilot fuel injector 70 in the nozzle head 64. The main fuel supply pipe 68 is for delivering main fuel to the main fuel injector outlet, or atomiser, 73 of the main fuel injector 72 in the nozzle head 64.

The fuel spray nozzle 260 is provided with the flange 88. The flange 88 is arranged at an upstream end portion of the feed arm 62 and may be achieved integrally with the housing 65. In the assembled engine 10, the fuel spray nozzle 260 may be secured to the combustor outer casing 90, for example by fasteners, e.g. bolts.

Within the nozzle head 64, a first air swirler passage 76 extends substantially centrally. Around the first air swirler passage 76, a first annular fuel passage 78 is formed. The first annular fuel passage 78 is connected to the primary pilot fuel supply pipe 267 and the secondary pilot fuel supply pipe 269 to provide pilot fuel and main fuel, respectively, to the pilot fuel injector 70.

A second air swirler passage 80 is provided concentrically radially outwardly of the first annular fuel passage 78, and a second annular fuel passage 82 is provided radially outwardly of the second air swirler passage 80. The second annular fuel passage 82 is connected to the main fuel supply pipe 68 to provide main fuel to the main fuel injector 72.

Each of the first and second air swirler passages 76, 80 receives air either from the low pressure compressor 14 or the high-pressure compressor 15, or both. The air swirler passages 76, 80 may include swirler vanes (not shown) to impart turbulence to the air. Similarly, the first and second annular fuel passages 78, 82 may also include swirler vanes (not shown) to impart turbulence to the fuel. A swirler head 84 may be provided on the outside of the second annular fuel passage 82 to provide further air to the main fuel injector 72.

In use, air from the first and second air swirler passages 76, 80 is mixed with pilot and main fuel from the first and second fuel passages 78, 82 to provide atomised fuel, to inject into the combustion chamber.

Similarly as for the fuel spray nozzle 60, although the fuel spray nozzle 260 has been described as having two air swirler passages, it will be appreciated that various alternatives are within the scope of the present disclosure. Purely by way of example, fuel spray nozzles with three, four, or five air swirler passages may be used. For example, three air swirler passage and four air swirler passage embodiments as illustrated with reference to the fuel spray nozzle 60 of FIG. 4 may be foreseen. Accordingly, the present disclosure extends to lean burn fuel spray nozzles 260 with a different architecture and having a different number of air swirler passages.

The fuel spray nozzle 260 further comprises a switching device, or staging valve, 174 similar to the switching device 74 illustrated with reference to the first embodiment, for controlling the division of fuel between the pilot fuel injector 70 and the main fuel injector 72. The same reference numerals are used to illustrate similar features. Mainly the differences between the switching device 74 of the first embodiment and the switching device 174 of the second embodiment will be described here.

The switching device 174 is arranged upstream of the feed arm 62 and the flange 88. In use, when the fuel spray nozzle 260 is connected to the combustor outer casing 90 at the flange 88, the switching device 174 is located radially outwardly of the combustor outer casing 90.

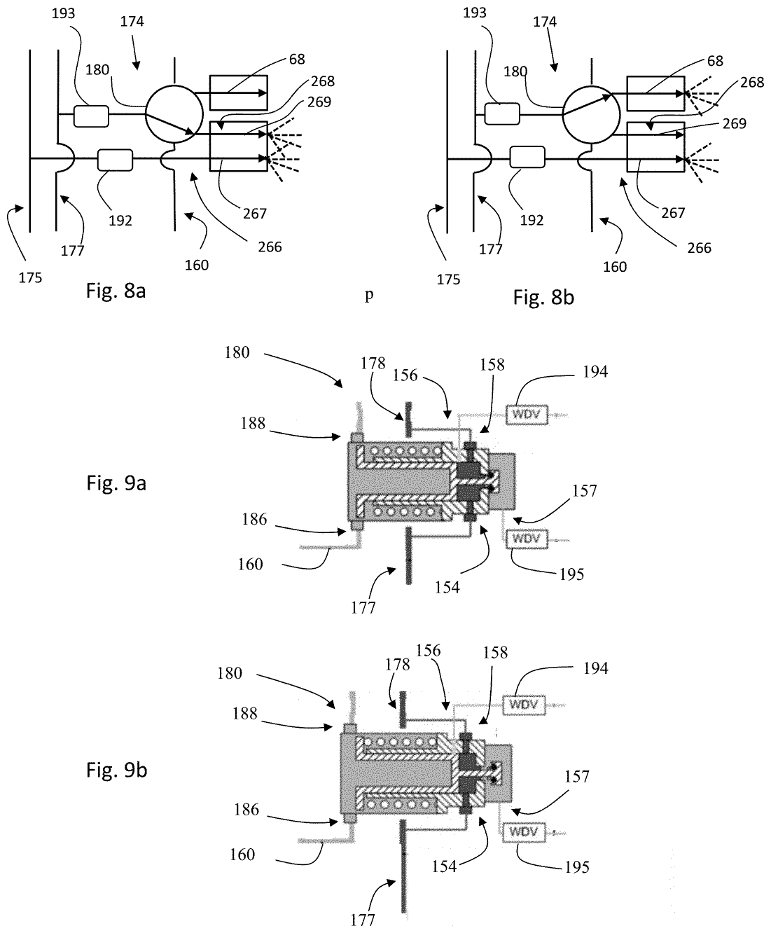

The switching device 174 will be now described with reference to FIGS. 8a and 8b, which show schematically a layout of switching device 174 according to a second embodiment in a Main Off position and Main On position, respectively.

The switching device 174 comprises a first inlet 176 for receiving pilot fuel from a pilot fuel supply through a pilot pipework 175 and a second inlet 178 for receiving main fuel from a main fuel supply through a mains pipework 177. The first inlet 176 of the switching device 174 receives pilot fuel from the pilot fuel supply and provides such pilot fuel to the primary pilot fuel circuit 266.

The switching device 174 further comprises a first outlet 179 for the main fuel to be delivered to the next fuel spray nozzle. The switching device 174 further comprises a switching valve 180 (shown as a circle in FIGS. 8a and 8b) configured to switch between a first, pilot-only (or main-off) position as shown in FIG. 8a, and a second, pilot and main (or staged, main-on) position as shown in FIG. 8b.

When in the pilot-only position, the switching valve 180 directs the main fuel from the main fuel supply to the secondary pilot fuel supply pipe 269 of the secondary pilot fuel circuit 268 of the fuel spray nozzle 260. In the pilot-only position all of the main fuel entering the switching valve 180 through the second inlet 178 is diverted to the secondary pilot fuel supply pipe 269. When in the pilot-only position, the mains pipework 177 is in fluid communication with the secondary pilot fuel supply pipe 269. When in the pilot-only position, the second inlet 178 is in fluid communication with the secondary pilot fuel circuit 268, and with the secondary pilot fuel supply pipe 269. Main fuel entering the switching valve 180 can be adjusted as necessary, depending on the mode of operation of the engine, the flight condition, and/or the environmental conditions, by means of any suitable metering devices and systems, such as valves, for example weight distribution valves. Allowing main fuel to flow in the secondary pilot fuel circuit 268 prevents the fuel in the mains pipework 177 to be stagnant and therefore to pick up heat. Compared with the known switching devices comprising on/off valves instead of the proposed switching valve 180, the present fuel spray nozzle allows fuel to continue to flow in the mains pipework 177 and therefore not to pick up heat.

When in the pilot and main position, the switching valve 180 directs the main fuel from the main fuel supply to the main fuel supply pipe 68 of the main fuel circuit 69. When in the pilot and main position, the main fuel circuit 69 and the mains pipework 177 are disconnected from the secondary pilot fuel circuit 268. In other words, when in the pilot and main position, main fuel is not fed to the secondary pilot fuel supply pipe 269.

In the fuel spray nozzle 260 the switching valve 180 is adapted to put the second inlet 178 in fluid communication with either the secondary pilot fluid supply pipe 269 (when the switching valve 180 is in the pilot-only position) or the main fuel supply pipe 68 (when the switching valve 180 is in the pilot and main position). In other words, the second inlet 178 of the switching device 174 receives main fuel from the main fuel supply, which in turn is provided to either the secondary pilot fuel circuit 268 or the main fuel circuit 69 depending on the position of the switching valve 180.

The primary pilot fuel circuit 266 is in fluid communication with the pilot pipework 175 at all the times, when the switching valve 180 is both in the pilot-only position and in the pilot and main position.

When in the pilot-only position, the pilot fuel injector 70 receives pilot fuel from the pilot pipework 175 through the first inlet 176 of the switching device 174 and main fuel from the mains pipework 177 through the second inlet 178 and the switching valve 180

The switching valve 180 may be actuated electrically (for example through the use of solenoids, motors, or similar), pneumatically or hydraulically. To this purpose, when actuated pneumatically or hydraulically, as in the embodiment of FIG. 4, the switching device 174 further comprises an additional, third inlet 186 and an additional, second outlet 188 for an actuation fluid, such as air, oil, or any other suitable fluid.

A first weight distribution valve 192 is arranged to adjust the pilot fuel flow in the primary pilot fuel supply pipe 267. A second weight distribution valve 193 is arranged to adjust the mail fuel flow upstream of the switching valve 180. Alternatively, as illustrated in FIGS. 9a and 9b, the second weight distribution valve 193 may be replaced by two separate weight distribution valves 194, 195, arranged downstream of the switching valve 180. The weight distribution valve 194 is arranged in the secondary pilot fuel circuit 268 to adjust the main fuel flow in the secondary pilot fuel supply pipe 269; the weight distribution valve 195 is arranged in the main fuel circuit 69 to adjust the main fuel flow in the main fuel supply pipe 68.

FIGS. 9a and 9b show schematically an example of switching valve 180 suitable to be used in the switching device 174 of FIG. 7 in more detail.

The switching valve 180 of the switching device 174 is substantially identical to the switching valve 180 of the switching device 74.

The switching valve 180 comprises a chamber containing a movable piston 150, biased by a spring 152. The piston 150 is pneumatically, or hydraulically actuated by means of an actuation fluid flowing in a fluid actuation circuit 160 and supplied via the additional inlet 186 and discharged via the additional outlet 188 .

The piston 150 is movable between a first position, corresponding to the pilot-only position of the switching valve 180, illustrated in FIG. 9a, and a second position, corresponding to the pilot and main position of the switching valve 180, illustrated in FIG. 9b.

When pressurised actuation fluid is provided to the switching valve 180, it exerts a force on the piston 150 that exceeds that of the spring 152, causing the piston 150 to move to, and maintain, the second position. When pressure of the actuation fluid is released, the spring 152 biases the piston 150 back to the first position.

The switching valve 180 may be understood as a four-way valve, with an input 154 for receiving main fuel from the second inlet 178 of the switching device 74, and a first 156, a second 157, and a third 158 output to deliver main fuel to the secondary pilot fuel circuit 268, the main fuel circuit 69, and the next fuel spray nozzle, respectively. In other words, the third output 158 of the switching valve 180 is in fluid communication with the first outlet 179 of the switching device 174 to deliver main fuel to the next fuel spray nozzle 260.

When in the first position, the piston 150 closes the second output 157 and opens the first and third output 156, 158, allowing the input 154 to be in fluid communication with the secondary pilot fuel circuit 268 and the next fuel spray nozzle 260. In other words, when the piston 150 is in the first position, main fuel entering the switching valve 180 is directed towards the secondary pilot fuel supply pipe 269 and the mains pipework 177.

When in the second position, the piston 150 closes the first output 156 and opens the second output 157 (the third outlet 158 remains open), allowing the input 154 to be in fluid communication with the main fuel circuit 69 and the next fuel spray nozzle 260. In other words, when the piston 150 is in the second position, main fuel entering the switching valve 180 is directed towards the main fuel supply pipe 68 and the mains pipework 177.

It is to be noted that the third output 158 is open both in the first position and in the second position of the piston 150, allowing main fuel to flow in the mains pipework 177 at all times, as in the first embodiment.

In alternative, non-illustrated embodiments, the switching valve may be configured such that when pressurised actuation fluid is provided, the piston 150 moves to the first position in which the second outlet 157 is closed and the inlet 154 is in fluid communication with the first output 156 to deliver main fuel to the secondary pilot fuel supply pipe 269 and with the third outlet 158, whereas when pressure of the actuation fluid is released, the piston 150 moves to the second position in which the first output 156 is closed and the inlet 154 is in fluid communication with the second output 157 to deliver main fuel to the main fuel circuit 69 and with the third outlet 158.

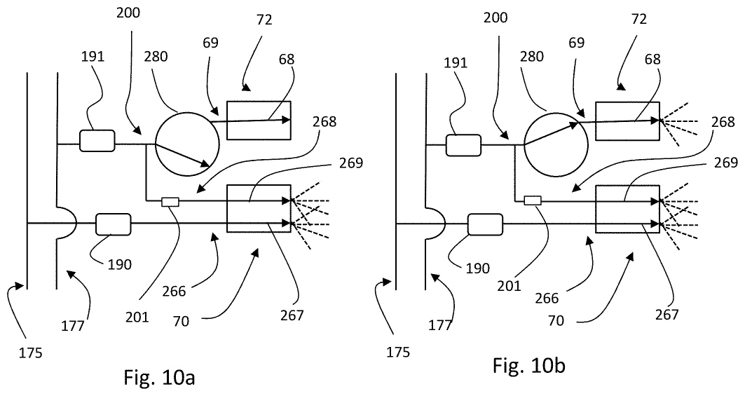

FIGS. 10a and 10b illustrate a layout of a further embodiment of switching device, or staging valve, 274 adapted to be used in the fuel spray nozzle 260 instead of the switching device 174 illustrated with reference to FIGS. 7-9b.

The switching device 274 controls the division of fuel between the pilot fuel injector 70 and the main fuel injector 72.

The switching device 274 is arranged upstream of the feed arm 62 and the flange 88. In use, when the fuel spray nozzle 260 is connected to the combustor outer casing 90 at the flange 88, the switching device 274 is located radially outwardly of the combustor outer casing 90.

A layout of the switching device 274 is schematically illustrated in a Main Off position in FIG. 10a and in a Main On position in FIG. 10b.

The switching device 274 is in fluid communication with the pilot pipework 175 via a first inlet 176 to provide pilot fuel to the primary pilot fuel circuit 266 and with the mains pipework 177 via a second inlet 178 to provide main fuel to the main fuel circuit 69 and to the secondary pilot fuel circuit 268.

A pilot weight distributor valve 190 is arranged along the primary pilot fuel circuit 266 upstream of the pilot fuel injector 70.

The switching device 274 further comprises a switching valve 280 (shown as a circle in FIGS. 10a and 10b) configured to switch between a first, pilot-only (or main-off) position as shown in FIG. 10a, and a second, pilot and main (or staged, main-on) position as shown in FIG. 10b.

A main weight distributor valve 191 is arranged upstream of the main fuel injector 72, for example upstream of the switching valve 280. In non-illustrated embodiments the main weight distributor valve 191 may be arranged along the main fuel circuit 69 downstream of the switching valve 280.

The main difference between the switching device 274 and the switching device 174 is that the mains pipework 177 is permanently connected to the secondary pilot fuel circuit 268 such that main fuel is always flowing in the secondary pilot fuel circuit 268 irrespective of the position of the switching device 280. To this purpose, the secondary pilot fuel circuit 268 is connected to the mains pipework 177 upstream of the switching device 274 at a junction 200. The junction 200 may be arranged downstream of the main weight distributor valve 191. The junction 200 splits the main fuel between the secondary pilot fuel circuit 268 and the switching valve 280. As the switching valve 280 is arranged in the main fuel circuit 69 downstream of the junction 200, the main fuel flow in the secondary pilot fuel circuit 268 is substantially unaffected by the switching valve 280 being in the pilot-only position or in the pilot and main position.

A passageway restriction 201 may be arranged in the secondary pilot fuel circuit 268 downstream of the junction 200 to ensure that only a known and comparably low flow can emerge into the secondary pilot fuel circuit 268. When main is staged in and the flow through the main fuel circuit 69 increases, the passageway restriction 201 limits the amount of flow that can be “lost” to the secondary pilot fuel circuit 268. If necessary, the flow in the primary pilot fuel circuit 266 may be changed to offset the increased flow in the secondary pilot fuel circuit 268, for example by means of the pilot weight distributor valve 190, or other dedicated valves. For example, when main is staged in, the fuel flow in the secondary pilot fuel circuit 268 is less than 1:10 of the fuel flow in the main fuel circuit 69.

When in the pilot-only position, the switching valve 280 prevents the main fuel from entering the main fuel supply pipe 68. When in the pilot-only position, the mains pipework 177 is not in fluid communication with the main fuel circuit 69.

When in the pilot and main position, the switching valve 280 puts the mains pipework 177 in fluid communication with main fuel supply pipe 68.

The switching valve 280 may be actuated electrically (for example through the use of solenoids, motors, or similar), pneumatically or hydraulically, for example by means of actuation fluid, such as air, oil, or any other suitable fluid.

The secondary pilot fuel circuit 268 is in fluid communication with the mains pipework 177 both when the switching valve 280 is in the pilot-only position and when the switching valve 280 is in the pilot and main position.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A lean burn fuel spray nozzle comprising:
a lean burn fuel spray nozzle head comprising a pilot fuel injector with a pilot fuel injector outlet and a main fuel injector with a main fuel injector outlet;
a feed arm adapted to feed pilot fuel from pilots pipework to the pilot fuel injector through a pilot fuel circuit and feed main fuel from mains pipework to the main fuel injector through a main fuel circuit; and
a switching device arranged upstream of the feed arm, the switching device comprising a switching valve adapted to switch between a Main On position, wherein the main fuel injector outlet is in fluid communication with the mains pipework through the main fuel circuit such that main fuel is adapted to flow through the main fuel injector and be sprayed through the main fuel injector outlet, and a Main Off position, wherein the main fuel injector outlet is not in fluid communication with the mains pipework through the main fuel circuit and main fuel is prevented to flow through the main fuel injector,
wherein the switching valve in the Main Off position is adapted to put the mains pipework in flow communication with the pilot fuel injector through the pilot fuel circuit such that main fuel is permitted to flow in the pilot fuel circuit.

2. The lean burn fuel spray nozzle of claim 1, wherein when the switching valve is in the Main Off position main fuel flowing in the main fuel circuit is sprayed through the pilot fuel injector outlet.

3. The lean burn fuel spray nozzle of claim 1, further comprising a flange adapted to secure the lean burn fuel spray nozzle to a combustor outer casing, the switching device being arranged upstream of the flange.

4. The lean burn fuel spray nozzle of claim 1, wherein the pilot fuel circuit comprises a primary pilot fuel circuit including a primary pilot fuel supply pipe and a secondary pilot fuel circuit including a secondary pilot fuel supply pipe wherein the primary pilot fuel supply pipe and the secondary pilot fuel supply pipe are configured to supply respectively pilot fuel and main fuel to the pilot fuel injector outlet.

5. The lean burn fuel spray nozzle of claim 4, wherein, when the switching valve is in the Main Off position, the secondary pilot fuel circuit is in fluid communication with the mains pipework.

6. The lean burn fuel spray nozzle of claim 5, wherein, when the switching valve is in the Main Off position, main fuel from the mains pipework and pilot fuel from the pilots pipework are sprayed through the pilot fuel injector outlet.

7. The lean burn fuel spray nozzle of claim 4, wherein, when the switching valve is in the Main On position, the secondary pilot fuel circuit is not in fluid communication with the mains pipework.

8. The lean burn fuel spray nozzle of claim 7, wherein, when the switching valve is in the Main On position, main fluid flows in the main fuel circuit only.

9. The lean burn fuel spray nozzle of claim 4, wherein the secondary pilot fuel circuit is connected to the mains pipework upstream of the switching valve at a junction.

10. The lean burn fuel spray nozzle of claim 9, wherein when the switching valve is in the Main On position, the secondary pilot fuel circuit is in fluid communication with the mains pipework,

11. The lean burn fuel spray nozzle of claim 10, further comprising a passageway restriction arranged in the secondary pilot fuel circuit downstream of the junction to limit the amount of main fuel flowing in the secondary pilot fuel circuit when the switching valve is in the Main On position.

12. The lean burn fuel spray nozzle of claim 11, wherein the passageway restriction is configured to provide a ratio of the mass flow rate of main fuel flowing in the secondary pilot fuel circuit to the mass flow rate of main fuel flowing in the main fuel circuit less than 0.5, or less than 0.1 when the switching valve is in the Main On position.

13. The lean burn fuel spray nozzle of claim 12, wherein the passageway restriction is configured to provide the ratio of the mass flow rate of main fuel flowing in the secondary pilot fuel circuit to the mass flow rate of main fuel flowing in the main fuel circuit greater than 0.0001, or greater than 0.001 when the switching valve is in the Main On position.

14. The lean burn fuel spray nozzle of claim 1, further comprising a non-return valve arranged between the pilot fuel circuit and the main fuel circuit.

15. The lean burn fuel spray nozzle of claim 14, wherein the switching valve comprises an inlet adapted to receive main fuel from the mains pipework, a main outlet in fluid communication with the main fuel injector and a pilot outlet in fluid communication with the pilot fuel injector, the lean burn fuel spray nozzle further comprising a connecting pipe adapted to connect the pilot outlet of the switching device with the pilot fuel circuit, the non-return valve being arranged along the connecting pipe.

16. The lean burn fuel spray nozzle of claim 14, wherein the non-return valve is arranged upstream of the switching valve.

17. A gas turbine engine comprising:
a fan comprising a plurality of fan blades;
an engine core comprising a compressor, a combustor, a turbine, and a core shaft connecting the turbine with the compressor;
wherein the combustor comprises a combustion chamber and a plurality of lean burn fuel spray nozzles, each lean burn fuel spray nozzle comprising:
a lean burn fuel spray nozzle head comprising a pilot fuel injector with a pilot fuel injector outlet and a main fuel injector with a main fuel injector outlet;
a feed arm adapted to feed pilot fuel from pilots pipework to the pilot fuel injector through a pilot fuel circuit and feed main fuel from mains pipework to the main fuel injector through a main fuel circuit; and
a switching device arranged upstream of the feed arm, the switching device comprising a switching valve adapted to switch between a Main On position, wherein the main fuel injector outlet is in fluid communication with the mains pipework through the main fuel circuit such that main fuel is adapted to flow through the main fuel injector and be sprayed through the main fuel injector outlet, and a Main Off position, wherein the main fuel injector outlet is not in fluid communication with the mains pipework through the main fuel circuit and main fuel is prevented to flow through the main fuel injector,
wherein the switching valve in the Main Off position is adapted to put the mains pipework in flow communication with the pilot fuel injector through the pilot fuel circuit such that main fuel is permitted to flow in the pilot fuel circuit.

18. The gas turbine engine of claim 16, further comprising a gearbox that receives an input from the core shaft and outputs drive to the fan so as to drive the fan at a lower rotational speed than the core shaft.

19. The gas turbine engine of claim 17, further comprising a non-return valve arranged between the pilot fuel circuit and the main fuel circuit.

20. The gas turbine engine of claim 17, wherein the switching valve comprises an inlet adapted to receive main fuel from the mains pipework, a main outlet in fluid communication with the main fuel injector and a pilot outlet in fluid communication with the pilot fuel injector, the lean burn fuel spray nozzle further comprising a connecting pipe adapted to connect the pilot outlet of the switching device with the pilot fuel circuit, the non-return valve being arranged along the connecting pipe.
